(19) United States
(12) Patent Application Publication
(10) Pub. No.: US 2021/0233131 A1
(43) Pub. Date: Jul. 29, 2021

(54) BENEFIT-PROVIDING DISCOUNT MALL SYSTEM AND OPERATION METHOD THEREOF

(71) Applicant: Chung Jong LEE, Gangwon-do (KR)

(72) Inventor: Chung Jong LEE, Gangwon-do (KR)

(21) Appl. No.: 17/052,028

(22) PCT Filed: May 7, 2019
(86) PCT No.: PCT/KR2019/005430

§ 371 Date: Oct. 30, 2020

(30) Foreign Application Priority Data
May 8, 2018 (KR) 10-2018-0052646

(51) Int. Cl. G06Q 30/06; G06Q 30/02

(52) U.S. Cl. CPC G06Q 30/0605; G06Q 30/0633; G06Q 30/0205; G06Q 30/0207; G06Q 30/0206; G06Q 30/0613

(57) ABSTRACT

A welfare-type under-mall system includes a web server configured to receive supply product information of a supplier and customer group information of a customer group, a DB server configured to store the supply product information and the customer group information, and a template creation server for creating a welfare provision template, whereby a fact that a company provides a supply product at a discounted price may not be informed to the general public, thus protecting a brand value of the company, and members of the customer group may be provided with a supply product at a discounted price unlike other general customers.

### BACKGROUND OF THE DISCLOSURE

### Technical Field

The present disclosure relates to a welfare-type under-mall system and an operation method thereof, and in particular, to a welfare-type under-mall system and an operation method thereof in which specific suppliers registered in the system provide supply products provided at a discounted price to members of specific customer groups registered in the system through an event, and here, an organizer of the event is recognized as a specific customer group by the members.

### Background Art

Recently, transactions of goods (i.e., products or articles) or services between companies and consumers have been conducted through electronic commerce (EC). However, due to excessive competition, products of companies increase in stock, and to solve this problem, the products in stock are increasingly handled at an under price (discounted price). In particular, as a difference between products supplied by department stores and products supplied by outlets gradually vanishes, there is a problem that a value of corporate brands decreases.

Meanwhile, companies or groups of a certain size or larger (e.g., the Military Mutual Aid Association) operate their own online closed malls. Online closed malls refer to closed online welfare malls or shopping malls that users related to specific companies may use, unlike general online shopping malls that anyone may access and use. In general, online closed malls tend to be limitedly used only by customers related to companies or internal members of companies or are simply used as web pages for corporate promotion, rather than properly serving as welfare malls or shopping malls that may provide various benefits to online closed mall users. Therefore, users' interest in or necessity of online closed malls gradually decreases.

(Patent document 1) Korean Patent Laid-Open Publication No. 10-2010-0089760 (Publication date: Aug. 12, 2010)

### SUMMARY

### Technical Problem

An aspect of the present disclosure provides a welfare-type under-mall system and an operation method thereof capable of hiding a fact from purchasers that products are supplied at a discounted price to protect a brand value of a company and capable of supplying products to internal members at a discounted price through an internal online closed mall to thereby improve the welfare of the members.

### Technical Solution

According to various embodiments of the present disclosure, a welfare-type under-mall system includes: a web server configured to receive supply product information of a supplier and customer group information of a customer group; a DB server configured to store the supply product information and the customer group information; and a template creation server for creating a welfare provision template, wherein the template creation server is configured to check a supply product and a discount rate included in the supply product information, to determine at least one customer group to which the supply product is to be supplied from the customer group information, and to create the welfare provision template such that members of the at least one customer group recognize that an organizer of an event providing the supply product is the at least one customer group based on the information on the supply product, the discount rate, and the at least one determined customer group.

According to various embodiments of the present disclosure, a method of operating a welfare-type under-mall system including a web server configured to receive supply product information and customer group information; a DB server configured to store the supply product information and the customer group information; and a template creation server configured to create a welfare provision template, including: checking a supply product and a discount rate included in the supply product information; determining at least one customer group to which the supply product is to be supplied from the customer group information; and creating the welfare provision template such that members of the at least one customer group recognize that an organizer of an event providing the supply product is the at least one customer group based on the information on the supply product, the discount rate, and the at least one determined customer group.

### Advantageous Effects

As described above, the welfare-type under-mall system according to the present disclosure may not inform the general public on a fact that a company provides a supply product at a discounted price, thus protecting a brand value of the company.

Furthermore, since members of a customer group may be provided with a supply product at a discounted price unlike other general customers, thereby improving the welfare of the members.

### BRIEF DESCRIPTION OF THE DRAWINGS

FIG. 1 is a block diagram showing a welfare-type under-mall system according to an embodiment of the present disclosure.

FIG. 2 is a flowchart illustrating a welfare-type under-mall system according to an embodiment of the present disclosure.

FIG. 3 is a flowchart illustrating a method of providing a list of customer groups suitable for a supplier according to an embodiment of the present disclosure.

FIG. 4 is a flowchart for determining discount rates matched to income levels of members according to an embodiment of the present disclosure.

FIG. 5 is a flowchart for determining a customer group to which a supply product is to be supplied based on locations of the customer groups according to an embodiment of the present disclosure.

FIG. 6 is a flowchart for selecting one of customer groups in which some of members overlap with each other according to an embodiment of the present disclosure.

### BEST MODE

According to an aspect of the present disclosure, there is provided a welfare-type under-mall system including a web server configured to receive supply product information of a supplier and customer group information of a customer group, a DB server configured to store the supply product information and the customer group information, and a template creation server for creating a welfare provision template, wherein the template creation server is configured to check a supply product and a discount rate included in the supply product information, to determine at least one customer group to which the supply product is to be supplied from the customer group information, and to create the welfare provision template such that members of the at least one customer group recognize that an organizer of an event providing the supply product is the at least one customer group based on the information on the supply product, the discount rate, and the at least one determined customer group.

### MODE FOR CARRYING OUT THE INVENTION

Hereinafter, various embodiments of the present disclosure will be described in detail with reference to the accompanying drawings. In the following description, when a detailed description of the relevant known functions or configurations is determined to unnecessarily obscure the gist of the present disclosure, the detailed description will be omitted. The terms used henceforth are defined in consideration of the functions of the disclosure and may be altered according to the intent of a user or operator, or conventional practice. Therefore, the terms should be defined on the basis of the entire content of this disclosure.

Embodiments of a welfare-type under-mall system according to the present disclosure will be described with reference to the accompanying drawings. However, the present disclosure is not limited to the following embodiments but may be implemented in various different forms. The embodiments are provided only to complete disclosure of the present disclosure and to fully provide a person having ordinary skill in the art to which the present disclosure pertains with the category of the disclosure.

Various embodiments of the disclosure may be implemented by software (e.g., the program) including an instruction stored in a machine-readable storage media (e.g., an internal memory or an external memory) readable by a machine (e.g., a computer). The machine may be a device that calls the instruction from the machine-readable storage media and operates depending on the called instruction and may include the electronic device (e.g., the electronic device). When the instruction is executed by the processor (e.g., the processor), the processor may perform a function corresponding to the instruction directly or using other components under the control of the processor. The instruction may include a code created or executed by a compiler or an interpreter. The machine-readable storage media may be provided in the form of non-transitory storage media. Here, the term “non-transitory”, as used herein, is a limitation of the medium itself (i.e., tangible, not a signal) as opposed to a limitation on data storage persistency.

In accordance with an aspect of the disclosure, it may be provided as a part of a computer program product. The computer program product may be traded between a seller and a purchaser as a product. The computer program product may be distributed in the form of machine-readable storage medium (e.g., a compact disc read only memory (CD-ROM)) or may be distributed only through an application store (e.g., a Play Store™). In the case of online distribution, at least a portion of the computer program product may be temporarily stored or created in a storage medium such as a memory of a manufacturer's server, an application store's server, or an intermediation server.

Each component (e.g., the module or the program) according to various embodiments may include at least one of the above components, and a portion of the above sub-components may be omitted, or additional other sub-components may be further included. Alternatively or additionally, some components (e.g., the module or the program) may be integrated in one component and may perform the same or similar functions performed by each corresponding components prior to the integration. Operations performed by a module, a programming, or other components according to various embodiments of the disclosure may be executed sequentially, in parallel, repeatedly, or in a heuristic method. Also, at least some operations may be executed in different sequences, omitted, or other operations may be added.

In addition, although an object of a transaction is referred to an article or goods in this disclosure, it is not necessarily limited to a product and it may target human services such as job service, tax service, and legal service. In addition, it should be noted in advance that a target object of a transaction may be extended to any object where the transaction may be made.

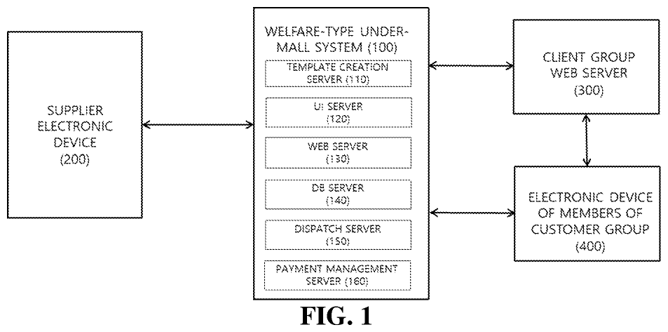

FIG. 1 is a block diagram showing a welfare-type under-mall system according to an embodiment of the present disclosure.

Referring to FIG. 1, the welfare-type under-mall system according to the present disclosure may be a system providing supply a product from a supplier to a customer group and members of the customer group at an under price (i.e., a discount rate-applied price, which will be referred to as a discounted price). Here, the supplier and the customer group may have a concept including a plurality of suppliers and a plurality of customer groups. For example, the supplier may include a manufacturer, a distributor, a service provider, a content provider, a lodging company (i.e., an accommodation company), and the like. In addition, the customer group may be one of a company, an institution, a civic group, an organization, an alumni association, a club, and a religious group. Of course, the supplier and the customer group are not limited to the above examples and may be any supplier and any customer group as long as they provide a supply product and consume a supply product.

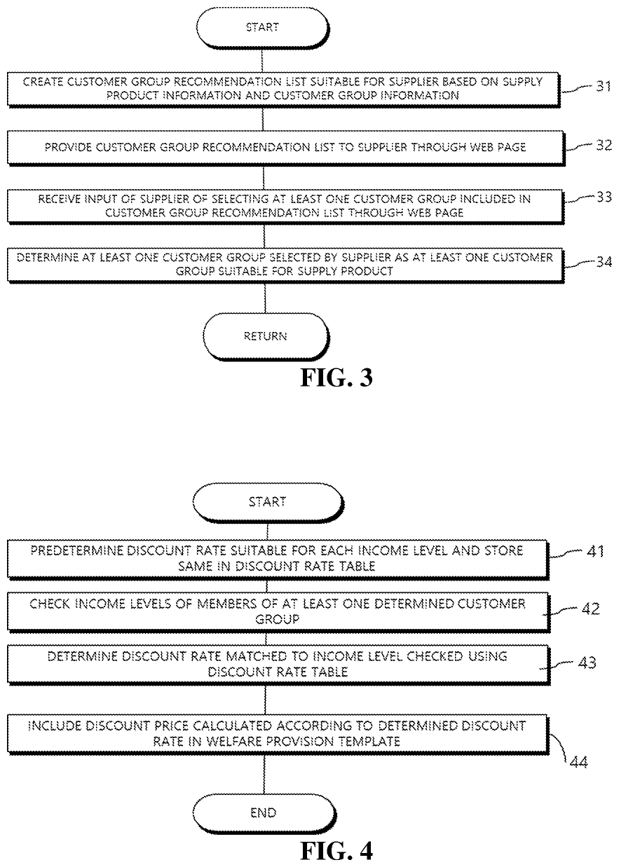

In an embodiment, the supplier and the customer group may sign up for membership through a web page provided by a web server 130 of the welfare-type under-mall system 100. The supplier may register own products and discount rates thereof through the welfare-type under-mall system 100, and the customer group may provide a supply product at a discounted price to members of the customer group using a welfare provision template provided by the welfare-type under-mall system 100. Here, the supply product has a concept including manufactured products, contents, performance products, accommodation products, wholesale products, or distribution products. Here, the discount rate may be at least 1% to 99%, and the range of such discount rate may be predetermined by the supplier. In addition, an actually applied discount rate may be determined within the range of a discount rate set by the supplier in consideration of an income level or the like of the customer group. Details thereof will be described later in FIG. 4.

In an embodiment, the welfare provision template may include event content hosted by a customer group, detailed information of the supply product, a design suitable for each customer group, and the like, and the event content hosted by a customer group may include a special exhibition that sells products of supplies to members at a discounted price. A design suitable for a customer group may be directly registered by the customer group or created by the UI server 120.

The welfare-type under-mall system 100 according to an embodiment of the present disclosure may include a template creation server 110, a UI server 120, a web server 130, a DB server 140, a dispatch server 150, and a payment management server 160. The welfare-type under-mall system 100 may receive supply product information from a supplier electronic device 200 using a plurality of servers and may receive customer group information from a web server 300 of the customer group. The welfare-type under-mall system 100 may be communicatively connected to the supplier electronic device 200, the customer group web server 300, and an electronic device 400 of members of the customer group through a network. Here, the network may include a wireless network and a wired network. For example, the network may be a short-range communication network (e.g., Bluetooth, Wi-Fi direct, or infrared data association (IrDA), or a telecommunication network (e.g., a cellular network, the Internet, or a computer network (e.g., LAN or WAN)).

In an embodiment, the supplier and the customer group are not limited to any part of the world and may be entities that run the business. For example, the supplier's business area and a location of the customer group may be anywhere in the world.

In an embodiment, the template creation server 110, the UI server 120, the web server 130, the DB server 140, the dispatch server 150, and the payment management server 160 may interwork with each other, and information obtained by each server may be updated in the DB server 140. For example, if the supplier registers supply product information and the customer group hosts an event (e.g., a special offer event for members) through a welfare provision template, it may be considered that a first contract is established between the supplier and the customer group, and thereafter, when members of customer groups actually purchase supply products at a discounted price, it may be considered that a second contract is established, which thus considered as completion of the entire transaction contract. Here, an amount obtained by subtracting a certain fee from a purchase price of the members of the customer group may be delivered to the supplier.

In an embodiment, the template creation server 110 may create, store, and provide a welfare provision template to a customer group. Here, the welfare provision template may include event content hosted by a customer group, detailed information of a supply product, and a design suitable for each customer group, and the event content hosted by the customer group may include an event in which a supply product of a supplier is sold to members at a discounted price. Therefore, the customer group does not need to directly notify the members of the event (e.g., special offer event), and the welfare-type under-mall system 100 of the present disclosure may automatically notify the event of the customer group and the members of the customer group through the welfare provision template. In addition, since the welfare provision template includes content that the event organizer is the customer group, members of the customer group cannot recognize that the supply product that may be purchased through the event is an under-priced (discounted price) product supplied by the supplier.

In an embodiment, the template creation server 110 may manage supply product information and customer group information and update the DB server 140. In addition, the template creation server 110 may analyze the supply product information, the customer group information, and purchase history of the members of the customer group and process the information into a new form. For example, the new form of information may include a history of members of a customer group who have frequently purchased supply products of the supplier, a customer group recommendation list suitable for the supply product.

In an embodiment, when a request for correcting supply product information is received from the supplier or an additional supply product is registered, the template creation server 110 may update the same in the DB server 140 in real time and create a new welfare provision template.

For example, the supply product information may include a kind, an original price, a discounted price, and a delivery charge of a supply product, a company name and a place of an address of the supplier, and a business information of the supplier

For example, the customer group information may include names, descriptions, kinds, and locations of a plurality of customer groups, and the number, genders, ages, and income levels of members of the plurality of customer groups.

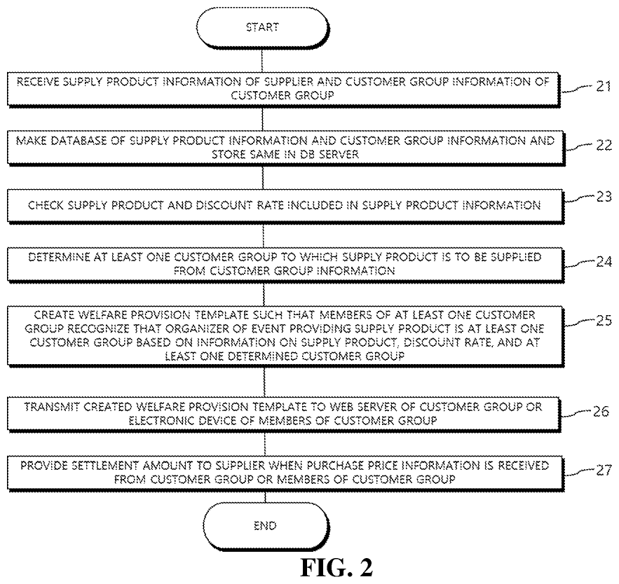

Creating the welfare provision template by the template creation server 110 will be described later in detail with reference to FIGS. 2 to 6.

In an embodiment, the UI server 120 may create and store menus, buttons, text, banners, and the like of a screen configuring a web page provided by the web server 130 and may provide them to the web server 130. In addition, the UI server 120 may provide various designs, languages, and the like to the template creation server 110 to create a welfare provision template. For example, supplier and customer groups may exist all over the world, and thus a language spoken in a country where customer groups are located, country-specific designs, and a UI provided by the customer group (e.g., a representative logo of a company) may be included so that a customer group may purchase the supply product of the supplier.

In an embodiment, the web server 130 may receive supply product information input through a web page and may receive customer group information input from a customer group. Alternatively, the web server 130 may receive supply product information from the supplier electronic device 200 and may receive customer group information from the customer group web server 300. For example, a web page provided by the web server 130 may be a web site which may be accessed by a supplier and a customer group online. The supplier may register supply product information through a web page, and the customer group may register customer group information through a web page. For example, the web server 130 may configure a web page using a language suitable for suppliers and customer groups that exist all over the world (e.g., a language of a country in which the supplier does business or a language of a country where the customer group is located), design, UI, and the like.

In an embodiment, the DB server 140 may make a database of supply product information, customer group information, and purchase history of members of the customer group, and a customer group recommendation list suitable for a supply product, and the like and store the same. For example, the DB server 140 may include a supply product management server that makes a database of supply product information and stores the same and a customer group management server that makes a database of customer group information and stores the same.

In an embodiment, the dispatch server 150 may transmit a welfare provision template to the customer group web server 300 or the electronic devices 400 of members of the customer group. For example, the dispatch server 150 may transmit the welfare provision template to the web server 300 of the customer group so that the welfare provision template may be registered as a notice on a web page provided by the web server 300 of the customer group. For example, the web page provided by the web server 300 of the customer group may be an online closed mall that only members of the customer group may access. For example, the dispatch server 150 may transmit the welfare provision template to the electronic device of the members of the customer group through at least one of a text program, a mail program, and an interactive program.

In an embodiment, the payment management server 160 may store and manage a purchase price of the members of the customer group, provide a settlement amount obtained by subtracting a certain fee to the supplier, and manage a purchase history.

FIG. 2 is a flowchart illustrating a welfare-type under-mall system according to an embodiment of the present disclosure.

Referring to FIG. 2, in an embodiment, in operation 21, the welfare-type under-mall system 100 may receive supply product information of a supplier and customer group information of a customer group. For example, the web server 130 may receive supply product information input from a supplier through a web page and may receive customer group information input from a customer group. In addition, the web server 130 may receive supply product information from the supplier electronic device 200 and may receive the customer group information from the customer group web server 130. As mentioned above, for example, the supply product information may include a kind, an original price, a discounted price, and a delivery charge of a supply product, a company name and a place of an address of the supplier, and a business information of the supplier. For example, the customer group information may include names, descriptions, kinds, and locations of a plurality of customer groups, and the number, genders, ages, and income levels of members of the plurality of customer groups.

In an embodiment, in operation 22, the welfare-type under-mall system 100 may make a database of the supply product information and the customer group information and store the same in the DB server 140. For example, the DB server 140 may receive the supply product information and the customer group information from the web server 130, make a database of the received product information and the customer group information, and store the same to analyze the information.

In an embodiment, in operation 23, the welfare-type under-mall system 100 may check the supply product and a discount rate included in the supply product information. For example, the template creation server 110 may check the supply product and discount rate in order to create a welfare provision template. In addition, the payment management server 160 may check the supply product and the discount rate in order to manage a payment price and a settlement amount. Here, the discount rate may be 1% to 99%. In addition, the range of the discount rate may be predetermined by the supplier and registered in the web server 130. Also, the template creation server 110 may determine a discount rate in advance in consideration of customer group information (e.g., an income level of members of the customer group). Details of the method of determining the discount rate will be described later in FIG. 4.

In an embodiment, in operation 24, the welfare-type under-mall system 100 determines at least one customer group to which the supply product is to be supplied from the customer group information. For example, the template creation server 110 may determine at least one customer group to which the supply product is to be supplied in consideration of names, descriptions, kinds, and locations of a plurality of customer groups, and the number, genders, ages, and income levels of members of the plurality of customer groups. For example, if the supply product is a hotel voucher and the quantity is 50, the template creation server 110 may determine a small business or alumni association as a customer group instead of a large company in consideration of the quantity.

In addition, in an embodiment, the template creation server 110 may determine a customer group to which the supply product is to be supplied in consideration of priority. For example, a purchase application may be received from a customer group in advance for a specific product, and the priority may be application order of the purchase application. That is, the template creation server 110 may first allocate a specific supply product to a customer group that has first applied.

In addition, according to an embodiment, the template creation server 110 may determine a customer group to which the supply product is to be supplied based on purchase history of a plurality of customer groups and members accumulated in the DB server 140. For example, if members of a customer group frequently purchase a specific supply product or a purchase quantity thereof is large, the template creation server 110 may determine the customer group that frequently purchases the specific supply product or a customer group with a large purchase quantity as a customer group to supply the product first.

Of course, without being limited to the above example, the template creation server 110 may determine a customer group to which the supply product is to be supplied in consideration of various methods and references.

In an embodiment, in operation 25, the welfare-type under-mall system 100 may create a welfare provision template so that members of at least one customer group recognize a host of an event for providing a supply product is at least one customer group based on information on the supply product, a discount rate, and at least one determined customer group. For example, the template creation server 110 may create a welfare provision template composed of text, design, and the like in consideration of the supply product, discount rate, and customer group information.

In an embodiment, the template creation server 110 may create each welfare provision template suitable for a plurality of customer groups based on purchase history of a plurality of customer groups that have purchased the supply product.

In an embodiment, the welfare provision template may include event content hosted by a customer group, a design suitable for each customer group, and the like, and event content hosted by the customer group may include an event in which a supply product of a supplier is sold to members at a discounted price. For example, the event content may be content in which a customer group organizes a seasonal event for the welfare of members as an organizer, specifically, a spring fashion event in which a large company A supplies spring clothing for members at a 30% discount, and here, the members of the customer group may recognize that an entity providing spring clothing corresponding to the supply product is not a supplier but a customer group. Accordingly, the supplier may supply the supply product at a discounted price only to specific purchasers, while protecting a value of a brand thereof, and the customer group may easily provide welfare to the members.

In an embodiment, in operation 26, the welfare-type under-mall system 100 may transmit the created welfare provision template to the web server 300 of the customer group or the electronic device 400 of the members of the customer group. For example, the dispatch server 140 may be provided with a welfare provision template from the template creation server 110 and transmit the welfare provision template to the web server 300 of the customer group or the electronic device 400 of members of the customer group. For example, the dispatch server 150 may transmit the welfare provision template to the web server 300 of the customer group so that the welfare provision template is registered as a notice on a web page provided by the web server 300 of the customer group. For example, the web page provided by the web server 300 of the customer group may be an online closed mall that only members of the customer group may access. For example, the dispatch server 150 may transmit the welfare provision template to the electronic device of the members of the customer group through at least one of a text program, a mail program, and an interactive program.

In an embodiment, in operation 27, the welfare-type under-mall system 100 may provide a settlement amount to the supplier when it receives purchase price information from the customer group or the members of the customer group. For example, the payment management server 160 may calculate the settlement amount when the purchase price information is received from the customer group or the members of the customer group, and may transmit a settlement amount obtained by subtracting a certain fee from a total purchase price to the web server 200 of the supplier.

FIG. 3 is a flowchart illustrating a method of providing a list of customer groups suitable for a supplier according to an embodiment of the present disclosure. FIG. 3 is an embodiment in which operation 24 of FIG. 2 is specifically described. That is, operation 24 of FIG. 2 is not limited to the example of FIG. 3, and operation 24 of FIG. 2 may be implemented in various embodiments as described in FIG. 2.

Referring to FIG. 3, in an embodiment, in operation 31, the welfare-type under-mall system 100 may create a customer group recommendation list suitable for a supplier based on supply product information and customer group information. For example, the template creation server 110 may create the customer group recommendation list in consideration of the supply product, a kind (e.g., large companies, mid-sized companies, small and medium-sized enterprises, institutions, NGOs, associations, alumni associations, clubs, religious groups) of the customer group, and the number, genders, ages, income levels, and locations of the members. For example, when the supply product is women's clothing, the template creation server 110 may create the customer group recommendation list including customer groups having a high female ratio.

In an embodiment, in operation 32, the welfare-type under-mall system 100 may provide the customer group recommendation list to a supplier through a web page. For example, the web server 130 may receive a customer group recommendation list from the template creation server 110 and display the customer group recommendation list through a web page.

In an embodiment, in operation 33, the welfare-type under-mall system 100 may receive an input from a supplier for selecting at least one customer group included in the customer group recommendation list through a web page. For example, the web server 130 may receive a supplier input for selecting at least one customer group. In other words, the supplier may determine by himself a customer group to supply a supply product thereof.

In an embodiment, in operation 34, the welfare-type under-mall system 100 may determine at least one customer group selected by the supplier as at least one customer group suitable for the supply product. For example, the template creation server 110 may determine the customer group selected by the supplier to create a welfare provision template as at least one customer group to which the supply product is to be supplied.

In an embodiment, the welfare-type under-mall system 100 may return to FIG. 2 after completing operation 34, may sequentially perform operations 25, 26, and 27 of FIG. 2, and then may terminate the process.

FIG. 4 is a flowchart for determining discount rates matched to income levels of members according to an embodiment of the present disclosure.

Referring to FIG. 4, in an embodiment, in operation 41, the welfare-type under-mall system 100 may determine in advance a discount rate suitable for each income level and store the same in a discount rate table. For example, the template creation server 110 may create and store a discount rate table in which each discount rate matched to each income level is determined. For example, a discount rate may be applied differently according to an average annual salary of the members of a company. For a customer group with a high average annual salary, a lower discount rate may be applied, and for a customer group with a low average annual salary, a higher discount rate may be applied. Here, the discount rate may be at least 1% to 99%, and an actual applied discount rate may be determined within the range of the discount rate in consideration of the income levels of members of the customer group.

In an embodiment, in operation 42, the welfare-type under-mall system 100 may check the income levels of the members of at least one determined customer group. For example, the template creation server 110 may check the income levels of the members (e.g., average annual salary of members in the customer group) based on the customer group information.

In an embodiment, in operation 43, the welfare-type under-mall system 100 may determine a discount rate matched to an income level checked using the discount rate table. For example, the template creation server 110 may determine a matched high discount rate when the checked income level is low.

In an embodiment, in operation 44, the welfare-type under-mall system 100 may include a discount price calculated according to the determined discount rate in the welfare provision template. For example, the template creation server 110 may write a discount price in the welfare provision template. For example, when the income level is low, a discount price to which a high discount rate is applied may be written in the welfare provision template.

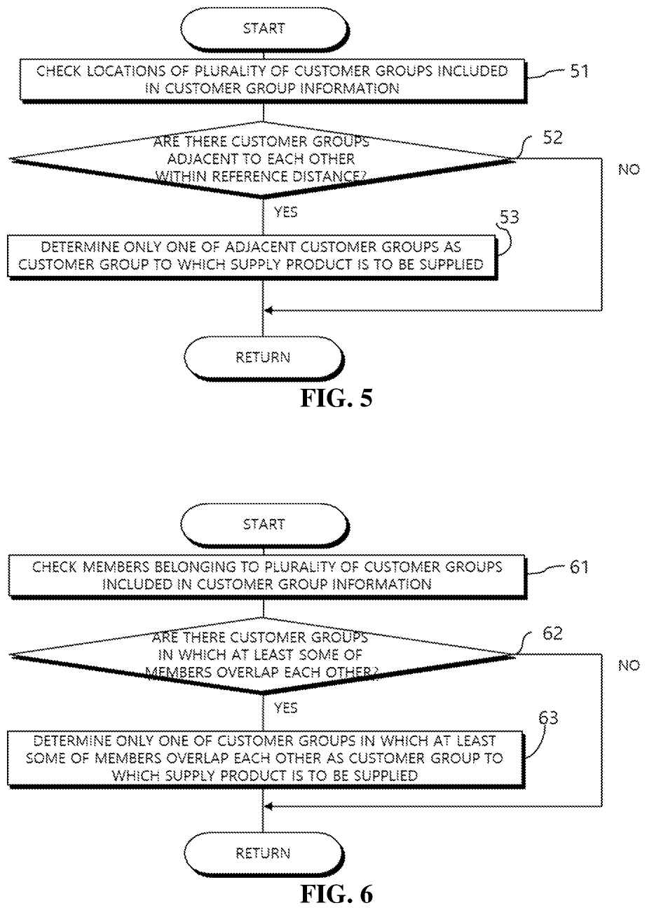

FIG. 5 is a flowchart for determining a customer group to which a supply product is to be supplied based on locations of customer groups according to an embodiment of the present disclosure. FIG. 5 shows an embodiment in which operation 24 of FIG. 2 is specified. That is, operation 24 of FIG. 2 is not limited to the embodiment of FIG. 5 and may be implemented in various embodiments as described in FIG. 2.

Referring to FIG. 5, in an embodiment, in operation 51, the welfare-type under-mall system 100 may check locations of a plurality of customer groups included in the customer group information. For example, the template creation server 110 may check a country in which customer groups are located, a specific geographical location, and the like.

In an embodiment, in operation 52, the welfare-type under-mall system 100 may check whether there are adjacent customer groups within a reference distance. Here, the reference distance may be set according to various references, and, for example, the template creation server 110 may check customer groups located close to each other (e.g., 10 km) based on the geographical locations of the customer groups. In addition, for example, the template creation server may determine that customer groups located in Jeollanam-do, Korea are customer groups adjacent to each other within a reference distance.

In an embodiment, if there are customer groups adjacent to each other within the reference distance, the welfare-type under-mall system 100 may determine only one customer group among the adjacent customer groups as a customer group to which the supply product is to be supplied in operation 53. For example, the template creation server may determine only one of the customer groups located in Jeollanam-do, Korea, as the customer group to which the supply product is to be supplied. In this manner, the supplier may prevent a brand value thereof from deteriorating. In addition, the welfare-type under-mall system 100 may return to FIG. 2 thereafter, sequentially perform operations 25, 26, and 27 of FIG. 2, and then terminate the process.

Meanwhile, in an embodiment, if there are no customer groups adjacent to each other within the reference distance, the welfare-type under-mall system 100 may immediately return to FIG. 2, sequentially perform operations 25, 26, and 27 of FIG. 2, and then terminate the process.

FIG. 6 is a flowchart for selecting one of customer groups in which some of members overlap each other according to an embodiment of the present disclosure. FIG. 6 shows an embodiment in which operation 24 of FIG. 2 is specified. That is, operation 24 of FIG. 2 is not limited to the example of FIG. 6 and may be implemented in various embodiments as described in FIG. 2.

Referring to FIG. 6, in an embodiment, in operation 61, the welfare-type under-mall system 100 may identify members belonging to each of a plurality of customer groups included in the customer group information. For example, the template creation server 100 may identify members of a mid-sized company A and an association B.

In an embodiment, in operation 62, the welfare-type under-mall system 100 may determine whether there are customer groups in which at least some of members overlap each other. For example, the template creation server 100 may determine whether at least some of the members of the mid-sized company A and the association B overlap.

In an embodiment, if there are customer groups in which at least some of the members overlap each other, the welfare-type under-mall system 100 may determine only one customer group among the overlapping customer groups as a customer group to which a supply product is to be supplied in operation 63. For example, if the association B is an association related to a mid-sized company so most members of the mid-sized company A join the association B, the template creation server 100 may determine the association B as a customer group to which a supply product is to be supplied. Meanwhile, after completing operation 63, the welfare-type under-mall system 100 may return to FIG. 2, sequentially perform operations 25, 26, and 27 of FIG. 2, and then terminate the process.

Meanwhile, in an embodiment, if there are no customer groups in which at least some of the members overlap each other, the welfare-type under-mall system 100 may immediately return to FIG. 2, sequentially perform operations 25, 26, and 27 of FIG. 2, and then terminate the process.

According to various embodiments of the present disclosure, a welfare-type under-mall system may include: a web server configured to receive supply product information of a supplier and customer group information of a customer group; a DB server configured to store the supply product information and the customer group information; and a template creation server for creating a welfare provision template, wherein the template creation server is configured to check a supply product and a discount rate included in the supply product information, to determine at least one customer group to which the supply product is to be supplied from the customer group information, and to create the welfare provision template such that members of the at least one customer group recognize that an organizer of an event providing the supply product is the at least one customer group based on the information on the supply product, the discount rate, and the at least one determined customer group.

According to various embodiments of the present disclosure, the web server may be configured to receive the supply product information input from the supplier through a web page and to receive the customer group information input from the customer group.

According to various embodiments of the present disclosure, the web server may be configured to receive the supply product information from an electronic device of the supplier and to receive the customer group information from a web server of the customer group.

According to various embodiments, the welfare-type under-mall system may further include: a dispatch server, wherein the dispatch server may be configured to transmit the welfare provision template to a web server of the customer group or an electronic device of members of the customer group.

According to various embodiments, the dispatch server may be configured to transmit the welfare provision template to the web server of the customer group such that the welfare provision template is registered as a notice in a web page provided by the web server of the customer group.

According to various embodiments, the web page provided by the web server of the customer group may be an online closed mall that only the members of the customer group are allowed to access.

According to various embodiments of the present disclosure, the dispatch server may be configured to transmit the welfare provision template to the electronic device of the members of the customer group through at least one of a text program, a mail program, and an interactive program.

According to various embodiments, the supplier may include a manufacturer, a distributor, a service provider, a content provider, and a lodging company.

According to various embodiments, the customer group may be one of a company, an organization, a civic group, an association, an alumni association, a club, a religious group.

According to various embodiments, the supply product information may include at least one of a kind, an original price, a discounted price, and a delivery charge of a supply product, a company name and a place of an address of the supplier, and a business information of the supplier.

According to various embodiments, the customer group information may include names, descriptions, kinds, and locations of a plurality of customer groups registered in the welfare-type under-mall system, and the number, genders, ages, and income levels of members of the plurality of customer groups.

According to various embodiments, the welfare-type under-mall system may further include a payment management server, wherein the payment management server may be configured to calculate a settlement amount when purchase price information is received from the customer group or the members of the customer group and to transmit the calculated settlement amount to a web server of the supplier.

According to various embodiments of the present disclosure, the DB server may include a supply product management server and a customer group management server.

According to various embodiments of the present disclosure, the template creation server may be configured to determine the at least one customer group to which the supply product is to be supplied based on kinds of customer groups and the number, genders, ages, income levels, and locations of members of the customer groups.

According to various embodiments of the present disclosure, the template creation server may be configured to determine the at least one customer group to which the supply product is to be supplied based on purchase history of a plurality of customer groups and members accumulated in the DB server.

According to various embodiments, the template creation server may be configured to make a database of purchase history of a plurality of users who has purchased the supply product through the welfare provision template and store the database in the DB server, and to create each welfare provision template suitable for the plurality of customer groups based on the purchase history.

According to various embodiments, the template creation server may be configured to create a customer group list suitable for the supplier based on the supply product information and the customer group information, to provide a customer group list to the supplier through a web page, and to determine at least one customer group selected by the supplier as at least one customer group suitable for the supply product if an input of the supplier that selects at least one customer group included in the customer group list is received through the web page.

According to various embodiments, the template creation server may be configured to predetermine a discount rate suitable for each income level and store each discount rate in a discount rate table, to check income levels of the members of the at least one determined customer group, to determine discount rates matched to the checked income levels using the discount rate table, and to include a price of the supply product calculated according to the determined discount rate in the welfare provision template.

According to various embodiments, the template creation server may be configured to check locations of a plurality of customer groups included in the customer group information and to determine only one of adjacent customer groups as a customer group to which the supply product is to be supplied if the customer groups are present adjacent to each other within a reference distance.

According to various embodiments, the template creation server may be configured to check members belonging to the plurality of customer groups included in the customer group information and to determine, if there are customer groups in which at least some of the members overlap each other, only one of customer groups in which at least some of the members overlap each other, as a customer group to which the supply product is to be supplied.

According to various embodiments of the present disclosure, a method of operating a welfare-type under-mall system including a web server configured to receive supply product information and customer group information, a DB server configured to store the supply product information and the customer group information, and a template creation server configured to create a welfare provision template, may include checking a supply product and a discount rate included in the supply product information, determining at least one customer group to which the supply product is to be supplied from the customer group information, and creating the welfare provision template such that members of the at least one customer group recognize that an organizer of an event providing the supply product is the at least one customer group based on the information on the supply product, the discount rate, and the at least one determined customer group.

Although the present invention has been described in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

### DESCRIPTION OF REFERENCE NUMERALS

100: welfare-type under-mall system
110: template creation server
120: UI server
130: web server
140: DB server
150: dispatch server
160: payment management server
200: supplier electronic device
300: customer group web server
400: electronic device of members of customer group

### INDUSTRIAL AVAILABILITY

The present disclosure relates to a welfare-type under-mall system and an operation method thereof. Since a fact that a company provides a supply product at a discounted price is not informed to the general public, a brand value of the company may be protected, and since members of a customer group are provided with a supply product at a discounted price unlike other general customers, the welfare of the members may be improved. The welfare-type under-mall system and the operation method thereof may be utilized for fields such as electronic commerce or the like.

What is claimed is:

1. A welfare-type under-mall system comprising:
a web server configured to receive supply product information of a supplier and customer group information of a customer group;
a DB server configured to store the supply product information and the customer group information; and
a template creation server for creating a welfare provision template,
wherein the template creation server is configured to check a supply product and a discount rate included in the supply product information, to determine at least one customer group to which the supply product is to be supplied from the customer group information, and to create the welfare provision template such that members of the at least one customer group recognize that an organizer of an event providing the supply product is the at least one customer group based on the information on the supply product, the discount rate, and the at least one determined customer group.

2. The welfare-type under-mall system of claim 1, wherein
the web server is configured to receive the supply product information input from the supplier through a web page and to receive the customer group information input from the customer group.

3. The welfare-type under-mall system of claim 2, wherein
the web server is configured to receive the supply product information from a supplier electronic device and to receive the customer group information from a web server of the customer group.

4. The welfare-type under-mall system of claim 1, further comprising:
a dispatch server,
wherein the dispatch server is configured to transmit the welfare provision template to a web server of the customer group or an electronic device of members of the customer group.

5. The welfare-type under-mall system of claim 4, wherein
the dispatch server is configured to transmit the welfare provision template to the web server of the customer group such that the welfare provision template is registered as a notice in a web page provided by the web server of the customer group.

6. The welfare-type under-mall system of claim 5, wherein
the web page provided by the web server of the customer group is an online closed mall that only the members of the customer group are allowed to access.

7. The welfare-type under-mall system of claim 4, wherein
the dispatch server is configured to transmit the welfare provision template to the electronic device of the members of the customer group through at least one of a text program, a mail program, and an interactive program.

8. The welfare-type under-mall system 1, wherein
the supplier comprises a manufacturer, a distributor, a service provider, a content provider, and a lodging company.

9. The welfare-type under-mall system of claim 1, wherein
the customer group is one of a company, an organization, a civic group, an association, an alumni association, a club, a religious group.

10. The welfare-type under-mall system of claim 1, wherein
the supply product information includes at least one of a kind, an original price, a discounted price, and a delivery charge of a supply product, a company name and a place of an address of the supplier, and a business information of the supplier.

11. The welfare-type under-mall system of claim 1, wherein
the customer group information includes names, descriptions, kinds, and locations of a plurality of customer groups registered in the welfare-type under-mall system, and the number, genders, ages, and income levels of members of the plurality of customer groups.

12. The welfare-type under-mall system of claim 1, further comprising:
a payment management server,
wherein the payment management server is configured to calculate a settlement amount when purchase price information is received from the customer group or the members of the customer group and to transmit the calculated settlement amount to a web server of the supplier.

13. The welfare-type under-mall system of claim 1, wherein
the DB server comprises a supply product management server and a customer group management server.

14. The welfare-type under-mall system of claim 1, wherein
the template creation server is configured to determine the at least one customer group to which the supply product is to be supplied based on kinds of customer groups and the number, genders, ages, income levels, and locations of members of the customer groups.

15. The welfare-type under-mall system of claim 1, wherein
the template creation server is configured to determine the at least one customer group to which the supply product is to be supplied based on purchase history of a plurality of customer groups and members accumulated in the DB server.

16. The welfare-type under-mall system of claim 1, wherein
the template creation server is configured to make a database of purchase history of a plurality of users who has purchased the supply product through the welfare provision template and stores the database in the DB server, and to create each welfare provision template suitable for the plurality of customer groups based on the purchase history.

17. The welfare-type under-mall system of claim 1, wherein
the template creation server is configured to create a customer group list suitable for the supplier based on the supply product information and the customer group information, to provide a customer group list to the supplier through a web page, and to determine at least one customer group selected by the supplier as at least one customer group suitable for the supply product if an input of the supplier that selects at least one customer group included in the customer group list is received through the web page.

18. The welfare-type under-mall system of claim 1, wherein
the template creation server is configured to predetermine a discount rate suitable for each income level and store each discount rate in a discount rate table, to check income levels of the members of the at least one determined customer group, to determine discount rates matched to the checked income levels using the discount rate table, and to include a price of the supply product calculated according to the determined discount rate in the welfare provision template.

19. The welfare-type under-mall system of claim 1, wherein
the template creation server is configured to check locations of a plurality of customer groups included in the customer group information and to determined only one of adjacent customer groups as a customer group to which the supply product is to be supplied if the customer groups are present adjacent to each other within a reference distance.

20. The welfare-type under-mall system of claim 1, wherein
the template creation server is configured to check members belonging to the plurality of customer groups included in the customer group information and to determine, if there are customer groups in which at least some of the members overlap each other, only one of customer groups in which at least some of the members overlap each other, as a customer group to which the supply product is to be supplied.

21. A method of operating a welfare-type under-mall system including a web server configured to receive supply product information and customer group information; a DB server configured to store the supply product information and the customer group information; and a template creation server configured to create a welfare provision template, the method comprising:
checking a supply product and a discount rate included in the supply product information;
determining at least one customer group to which the supply product is to be supplied from the customer group information; and
creating the welfare provision template such that members of the at least one customer group recognize that an organizer of an event providing the supply product is the at least one customer group based on the information on the supply product, the discount rate, and the at least one determined customer group.
